(19) United States
(12) Patent Application Publication
(10) Pub. No.: US 2004/0068550 A1
(43) Pub. Date: Apr. 8, 2004

(54) Method and device for delivering data

(75) Inventor: Fabio Giannetti, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/668,207

(22) Filed: Sep. 24, 2003

(30) Foreign Application Priority Data
Sep. 24, 2002 (GB) 0222216.4

(51) Int. Cl. G06F 15/167

(52) U.S. Cl. 709/215; 709/217; 709/246

(57) ABSTRACT

A method of delivering data to one or more data-handling devices, the method comprising the steps of: storing data that is intended for transmission to the data-handling device according to a predetermined template which provides a plurality of fields each of said fields being capable of containing a portion of the data; providing mappings that map the data within the fields of the predetermined template to fields within alternative templates should it be determined that the data-handling device is not capable of handling data held in the predetermined template; and transmitting the data to the data-handling device.

### FIELD OF THE INVENTION

This invention relates to a method and related apparatus for delivering data to one or more computing devices and in particular relates to a such a method and apparatus for delivery of the data to a remote computing device such as via a network such as the Internet.

### BACKGROUND OF THE INVENTION

Access to web pages on the World Wide Web (WWW) is one example of prior art for this invention and it is currently possible to gain access to a web page using a number of different devices, such as a desktop or laptop computer, a personal digital assistant (PDA), a web enabled television or directly to a mobile telephone. Thus, in principle, data posted on a web page, such as text and graphics is accessible by a consumer in possession of any one of these devices who is able also to avail themselves of the requisite network links. In practice however a significant but, to the lay person apparently trivial difficulty exists in disseminating data to all of these devices in a manner which is useable by a consumer: the device the consumer is using to make manifest the data may not be capable of manifesting elements of the data essential for comprehension of the information within it. Specifically for example a web page may not have been authored specially to enable viewing of its data on devices with a low capability such as a mobile telephone display (which generally have small monochrome and low resolution screens). If the author of the web page has therefore created the web page so that all or part of the essential information on the page required by the user is “coded” in the form of photographs, coloured text or animations and the like, then a user who is unable to fully display these elements of the data on their screen may effectively be unable to access the web page in any meaningful manner.

This problem is known, and is currently addressed in a number of different manners. According to one approach, data for a web page (for example) is authored independently of a consideration of the device on which the data is to be handled, other than perhaps to the extent that the author attempts to encode all important information in a manner which even the crudest form of device can handle. Once a request for a copy of the web page is received, an adaptation process, performed by a program which intermediates between the device which is to receive the data and the host device where the data is stored then takes place, in which an abridged version of the data appropriate to the device to which data is to be sent is extracted from the original data for the web page in question, and is sent to the receiving device.

A second approach involves authoring the page using computer code to author the data which is specifically appropriate for a particular class of requesting device (for example using hyper-text markup language Html) to author web pages for consumption by conventional desktop or laptop computers, which may mean having to author the page several times in order to enable manifestation of the page on several differing classes of device. In what may be termed a sub-class of this approach, data authored in a language specifically appropriate for one device is transformed into a language specifically appropriate to another class of device, possibly resulting in an unwanted loss or alteration of data as a result (in a manner analogous to the result of translating, for example, a German document into English using computer software).

The present invention tries to overcome or at least reduce the problems of the prior art.

### SUMMARY OF THE INVENTION

According to a first aspect of the invention there is provided a method of delivering data to one or more data-handling devices, the method comprising the steps of:

i. storing data that is intended for transmission to the data-handling device according to a predetermined template which provides a plurality of fields each of said fields is capable of containing a portion of the data;

ii. providing mappings that map the data within the fields of the predetermined template to fields within alternative templates should it be determined that the data-handling device is not capable of handling data held in the predetermined template; and

iii. transmitting the data to the data-handling device.

Such a method is advantageous because it allows data that is intended to be sent to a data-handling device to be mapped to other layouts whilst helping to maintain the structure of the data through use of the fields. Thus, it is likely that changing of the data from one layout to another layout may be achieved quicker and perhaps more effectively than with prior art methods. As such a reduction in processing power to achieve the same results in a given time may be expected, a reduction is storage space through more efficient use thereof may be achieved.

The method may comprise determining whether the data-handling device is capable of handling the predetermined template before transmission to the data-handling device and mapping the data using the mappings should it be determined that the data-handling device cannot handle the predetermined template. In such an embodiment the method ensures that the identity of the data-handling device to which the data will be sent is known such that the method can determine in advance whether the device will be able to handle the data. Such a method may be more efficient than other known methods.

In an alternative, or additional, embodiment the method may be arranged to make this determination after the data

has been transmitted to the data-handling device. For example, the method may cause the data-handling device to return an error message if the device cannot handle data in the predetermined template and should such an error message be generated then the data within the predetermined template may be mapped to another template using the mappings and re-sent. Such a method may be advantageous in situations in which the identity/class of device is not known before data is transmitted.

According to a second aspect of the invention there is provided a computing device capable of delivering data to one or more data-handling devices, the computing device comprising a receiving means for receiving a request for data, a transmitting means arranged to transmit data, a processing means arranged to process data and a storage means for storing data, the receiving means is arranged to communicate the receipt of a request for data to the processing means which is arranged, upon the receipt of such a communication, to retrieve data from the storage means which has been stored according to a predetermined template which provides a plurality of fields such that each of said fields is capable of containing a portion of the data, the storage means also being arranged to store mappings which are arranged to map data held in fields of the predetermined template to fields within alternative templates, said processing means being capable of mapping data stored in the predetermined template to alternative templates according to the mappings and sending the mapped data to the transmitting means for transmission.

According to a third aspect of the invention there is provided a network capable of delivering data to one or more data-handling devices, the network comprising a receiving means for receiving a request for data, a transmitting means arranged to transmit data, a processing means arranged to process data and a storage means for storing data, the receiving means is arranged to communicate the receipt of a request for data to the processing means which is arranged, upon the receipt of such a communication, to retrieve data from the storage means which has been stored according to a predetermined template which provides a plurality of fields such that each of said fields is capable of containing a portion of the data, the storage means also being arranged to store mappings which are arranged to map data held in fields of the predetermined template to fields within alternative templates, said processing means being capable of mapping data stored in the predetermined template to alternative templates according to the mappings and sending the mapped data to the transmitting means for transmission.

According to a fourth aspect of the invention there is provided a data-handling device capable of communicating with a computing device and/or network and receiving data therefrom, the data-handling means being arranged to communicate a parameter such that a method according to the first aspect of the invention can be applied to the data that is sent to the data-handling device.

According to a fifth aspect of the invention there is provided a machine-readable medium containing instructions which when read by a computing device cause that computing device substantially to perform the method of the first aspect of the invention.

According to a sixth aspect of the invention there is provided a machine-readable medium containing instructions which when read by a computing device cause that computing device to function substantially as the computing device of the second aspect of the invention.

According to a seventh aspect of the invention there is provided a machine-readable medium containing instructions which when read by a computing device of a network cause that network to function substantially according to the third aspect of the invention.

According to an eighth aspect of the invention there is provided a machine-readable medium containing instruction which when read by a data-handling device cause that data-handling device to function substantially as the data-handling device according to the fourth aspect of the invention.

According to a ninth aspect of the invention there is provided a method of delivering data to at least one data-handling device, the method comprising the steps of: storing data that is intended for transmission to the data-handling device in one of a plurality of predetermined templates each of which provides a plurality of fields and each of the fields being capable of containing a portion of the data; providing a plurality of mappings that map data held within a field of one of the predetermined templates to fields within an alternative template should it be determined that the data-handling device to which the data is to be sent is not capable of handling data held in the predetermined template; altering the data according to one of the mappings should it be determined that the data-handling device cannot handle the data; and transmitting the data to the data-handling device.

According to a tenth aspect of the invention there is provided a method of delivering data to at least one data-handling device, the method comprising the steps of: storing data that is intended for transmission to the data-handling device in one of a plurality of predetermined templates each of which provides a plurality of fields and each of the fields being capable of containing a portion of the data; providing a plurality of mappings that map data held within a field of one of the predetermined templates to fields within an alternative template should it be determined that the data-handling device to which the data is to be sent is not capable of handling data held in the predetermined template, the predetermined mappings including at least a preferred mapping which is performed in preference to other mappings should it be determined that a mapping is required and a default mapping that is performed if other mappings do not map the data such that it can be handled by the data-handling device; altering the data according to one of the mappings should it be determined that the data-handling device cannot handle the data; and transmitting the data to the data-handling device.

According to an eleventh aspect of the invention there is provided a computing device capable of delivering data to at least one data-handling device, the computing device comprising a receiver, a transmitter, a processor and a memory, the receiver is arranged to communicate the receipt of a request for data to the processor which is arranged, upon the receipt of such a request, to retrieve data from the memory which has been stored in the memory in one of a plurality of predetermined templates each of which provides a plurality of fields such that each of the fields is capable of containing a portion of the data, the memory also being arranged to store mappings which are arranged to map data held in fields of the predetermined template to fields within alternative templates, the processor being capable of mapping data stored in the predetermined template to alternative templates according to the mappings and sending the mapped data to the transmitter for transmission.

According to a twelfth aspect of the invention there is provided a network capable of delivering data to at least one data-handling device, the network comprising a receiver, a transmitter, a processor and a memory, the receiver is arranged to communicate the receipt of a request for data to the processor which is arranged, upon the receipt of such a request, to retrieve data from the memory which has been stored according to one of a plurality of predetermined templates each of which provides a plurality of fields such that each of the fields is capable of containing a portion of the data, the memory also being arranged to store mappings which are arranged to map data held in fields of the predetermined template to fields within alternative templates, the processor being capable of mapping data stored in the predetermined template to alternative templates according to the mappings and sending the mapped data to the transmitter for transmission.

According to a thirteenth aspect of the invention there is provided a method of sending data to at least one remote device, the method comprising the steps of: storing data that it is intended to send to the remote device in one of a plurality of predetermined templates each of which provides a plurality of fields and each of the fields allowing a portion of the data to be stored therein; providing a plurality of transformations that transform data held within one of the plurality of templates such that the data then corresponds to an alternative template such that data held in a field of one of the predetermined templates is moved to a field within the alternative template; transforming the data according to one of the transformations should it be determined that the remote device cannot handle the data as it is stored in the predetermined template; and sending the data to the remote device.

The template may be thought of as providing a model that may be used hold the data. The alternative templates may be thought of as alternative models. The transforms may therefore be thought of as transforming one model into a different model.

The machine-readable medium of any of the aspects of the invention may be any one or more of the following: a floppy disk; a CDROM; a DVD ROM/RAM (including +RW/−RW); a hard drive; memory; any form of magneto optical disk; any form of tape; a transmitted signal (which may an Internet download, a ftp transfer, or any other transmitted signal); a wire.

### BRIEF DESCRIPTION OF THE DRAWINGS

There now follows by way of example only a detailed description of one embodiment of the present invention with reference to the accompanying drawings of which:

FIG. 1 schematically shows the architecture of a server for one embodiment of this invention;

FIG. 2 schematically shows a number of data-handling devices having data connections to the server of FIG. 1

FIG. 3 schematically shows possible mappings for data held in a predetermined template to other templates;

FIG. 4 schematically shows possible mappings for data held in a second predetermined template to other templates;

FIG. 5 shows a flow chart outlining the process of an embodiment of the present invention; and

FIG. 6 schematically shows a two stage adaptation process suitable for use with the present invention.

### DETAILED DESCRIPTION OF THE DRAWINGS

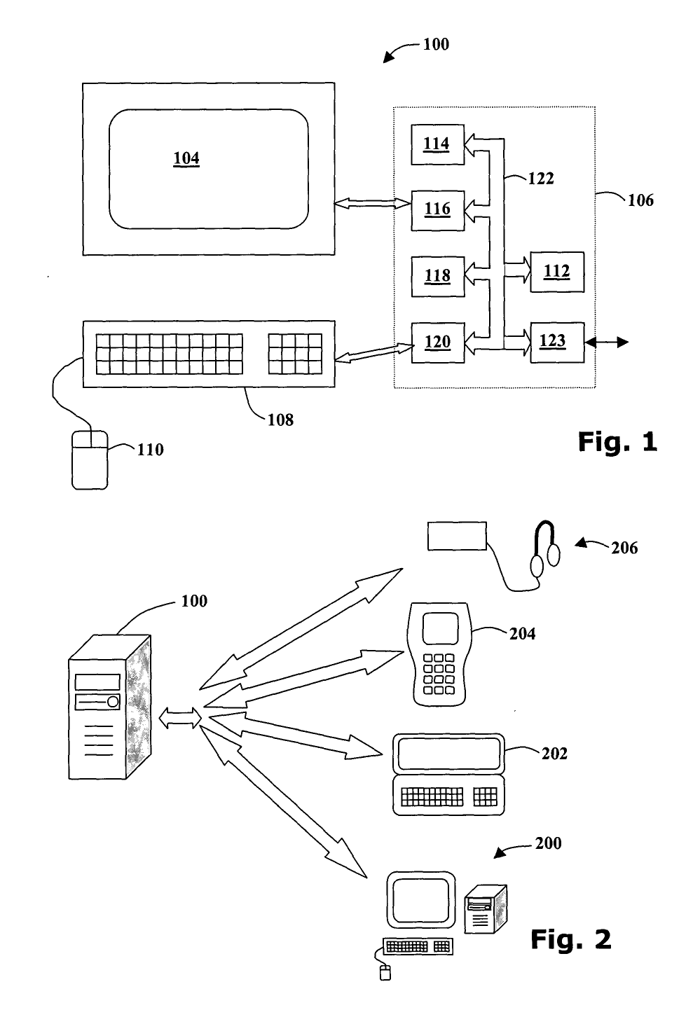

This particular invention is applicable to delivering data electronically, and in particular web content via the World Wide Web, or in short the web, although the invention does have wider application. Generally the data to be delivered is held on, or accessible by, a processing apparatus, or server 100, as shown in FIG. 1, and can be requested by any number of devices that are capable of communicating with the server 100. The data does not necessarily have to be sent to the device that requested the device and one device may request that data can be sent to another device.

In this embodiment the computing device, or server 100, comprises a display 104, processing circuitry 106, a keyboard 108, and mouse 110. The processing circuitry 106 further comprises a processing unit 112, a hard drive array 114, a video driver 116, memory 118 (RAM and ROM), a IP port 123 and an I/O subsystem 120 which all communicate with one another, as is known in the art, via a system bus 122. The processing unit 112 comprises an INTEL™ PENTIUM™ series processor, running at typically between 2 GHz and 2.5 GHz. The server 100 connects to a network via a network adapter 124, which provides a transmitting and receiving means for the server 100 and allows communication with the server 100 across a network to which the server 100 is attached.

It will be appreciated that although the computing device 100 is described as a server connected to a network it would be equally possible for the computing device to be un-networked and for transmission of data from the computing device 100 to occur over a direct connection to that computing device. The direct connection may be any form of connection suitable for transmitting data whether wireless or wired.

The IP port 123 allows the computing device, or server, 100 to communicate across a network and therefore may be thought of as providing a receiver and a transmitter. The skilled person will appreciate that other means such as MODEMs, IR links, BLUETOOTH connections and the like may also be possible.

As is known in the art the ROM portion of the memory 118 contains the Basic Input Output System (BIOS) that controls basic hardware functionality. The RAM portion of memory 118 is a volatile memory used to hold instructions that are being executed, such as program code, etc. The hard drive array 114 is used as mass storage for programs and other data although it is of course equally possible for data to be accessed across the network via the network adapter 124 from a remote storage means.

Thus, the memory 118 and hard drive array 114 provide storage means capable of holding data. It will be appreciated that such storage means need not be provided within the server 100 and may instead be provided remotely on a device that has a data connection to the server 100.

Other devices such as CDROMS, DVD ROMs, etc. could be coupled to the system bus 122 and allow for retrieval and/or storage of data from different media, etc.

The server 100 could have the architecture known as a PC, originally based on the IBM™ specification, but could equally have other architectures. The server may be an APPLE™, or may be a Reduced Instruction Set Computer (RISC) system, and may run a variety of operating systems (perhaps HP-UX, LINUX, UNIX, MICROSOFT™ NT, AIX™, or the like).

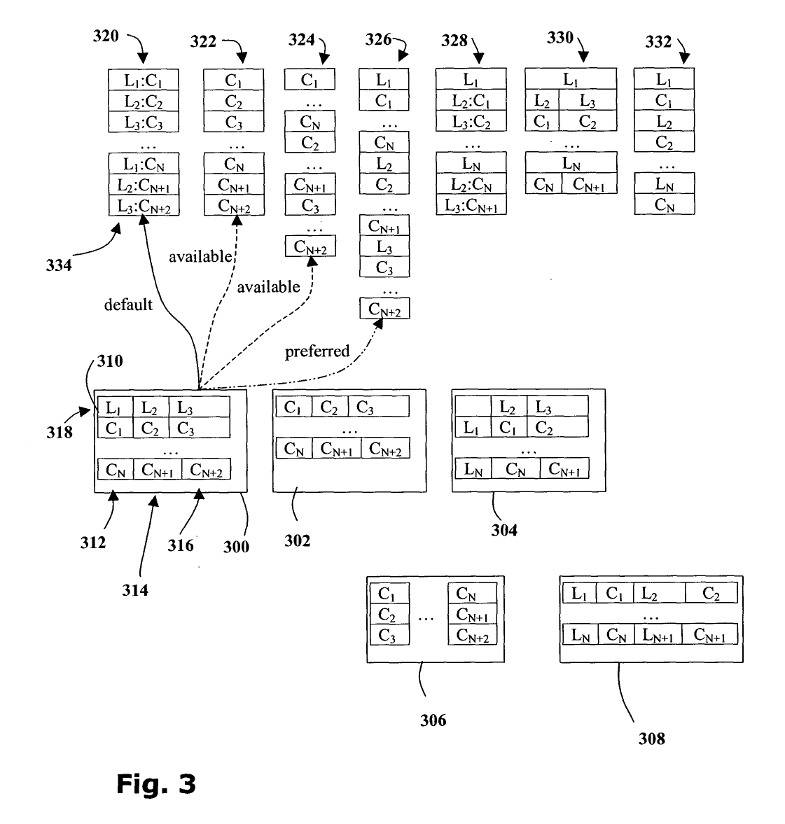

In this embodiment data providing web content, in this case a web-site comprising a number of pages, is held on the server 100. At least a portion of the web content is visual information comprising text, graphics, etc. It will be appreciated that the data could also comprise sound or any other data that it may be desired to transmit. At least portions of the data are stored according to predetermined templates as will be described with reference to FIG. 3. Storage of data in such templates may be particularly advantageous if the graphical data to be presented in tabular form. However, as will be expanded upon hereinafter it may be advantageous for other forms of data.

As shown in relation to FIG. 2 data may be sent to any one or more of a number of devices, such as, for example, to a desktop PC 200, to a Personal Digital Assistant (PDA) 202, to a mobile telephone 204, or to a headset 206 for listening to thereon. Each specific device 200-206 may be a member of a device class and will generally be a remote device, remote from the server 100. For example there may exist a device class of handheld devices and, generally, each device in that class would have roughly similar properties.

Turning to FIG. 3, five examples 300, 302, 304, 306, 308 of predetermined templates are shown in the lower half of the Figure each of which provides a plurality of fields capable of containing a portion of the data to provide the web site. In the embodiment being described, an author (whether a human, or machine) selects one of the predetermined templates 300-308 into which the data is stored. However, it is possible that further predetermined templates could be added if needed/desired. Each of the predetermined templates may be given a convenient title which tries to describe the layout of that template. For example the five predetermined templates may be termed as follows: first predetermined template 300 “a standard header”; the second predetermined template 302 “row ordered content”; the third predetermined template 304 “column ordered content”; the fourth template 306 “top side header”; and the fifth predetermined template 308 “side by side”.

Each of the predetermined templates allows an author to specify presentation of two dimensional data in a different manner and each predetermined template 300-308 provides a table in which the cells are ordered differently, with each cell providing a field into which a portion of the data can be added. In the embodiment of FIG. 3 the first predetermined template 300 (standard header) has been used to store a portion of the web site data on the server 100 and comprises a table 310 having a number of columns 312, 314, 316 (in this case three) with the first row 318 of each column containing label data (denoted by the letter “L”). The remaining rows of each column contain content data (sometimes referred to as content), labelled with a “C”. Because the data is stored in the predetermined template the content of each cell is therefore known; that is each field contains a portion of the data of a known type (label/content).

As discussed above the data, presented in tabular form, may be entirely graphical. However, it would be equally possible for either or both of the label data and content data to comprise sound clips, video clips, or any other form of multimedia. Thus, data providing the content/labels may comprise words, pictures, video, sound, or the like.

Since the contents of the cells is known it is possible to provide mappings that map the contents to other layouts. Again referring to FIG. 3, possible alternative layouts are provided by a number of alternative templates 320, 322, 324, 326, 328, 330, 332. For convenience these alternative templates may be given the following labels which try to describe the layout provided by the template: 320: head row list; 322: row list; 324: cell list; 326: head cell list; 328: row entry head row list; 330: row entry sub table; 332: alternative list.

Thus the data held in any one of the predetermined templates 300-308 may be mapped to any one of the alternative templates 320-332, although the data-handling devices to which it is intended to send data may not be able to handle (generally display) data in all of the alternative templates. In one embodiment the server is provided with models, or the like, for the five predetermined templates 300-308 and also for the seven alternative templates 320-332. Thus, to map data between the predetermined and alternative templates all that is the identity of the predetermined template in which the content/label data is held and identity of the alternative template to which the fields will be mapped. As can be seen from FIG. 3 the top left cell, labelled L₁, within the standard header predetermined template 300 is mapped to the first cell of the head cell list alternative template 326. Providing a plurality of predetermined templates is advantageous because it may provide a user with more of a choice as to how the data can be initially organised.

It will be appreciated that some of the alternative templates may present certain data better than others and indeed some of the alternative templates may present the data in such a way that some of the data-handling devices to which data may be sent may not be able to handle data held in that template.

Thus, a portion of the web site data may comprise data specifying which alternative templates is preferred, which alternative templates provide fall back templates, which provide alternative layouts, etc. The preferred alternative template may be specified by an author of the web site, or may be generated by a processing means of the server/network providing the web site. In the embodiment of FIG. 3 it can be seen that the head row list 320; the row list 322, the cell list 324 and the head cell list 326 alternative templates are specified as being capable of having the data held in the predetermined template 300 mapped thereto. The mapping to the head row list 320 alternative template is defined as the default mapping (i.e. the mapping that is used if a preferred mapping does not work). The mapping to the head cell list 326 alternative template is defined as the preferred mapping, which is used if possible. The mapping to the row list 322 and cell list 324 alternative templates which are used if neither the preferred nor the default alternative templates are suitable.

An example of a useful use of an embodiment of this invention is in the table serialisation for PDA consumption in which the layout itself does not indicate the order in which the information needs to be serialised. Adding a template to which the data must conform may help the processor performing the adaptation to serialise the table maintaining a logical order to the content and preserving the content relationships expressed, as spatial relationships, within the table.

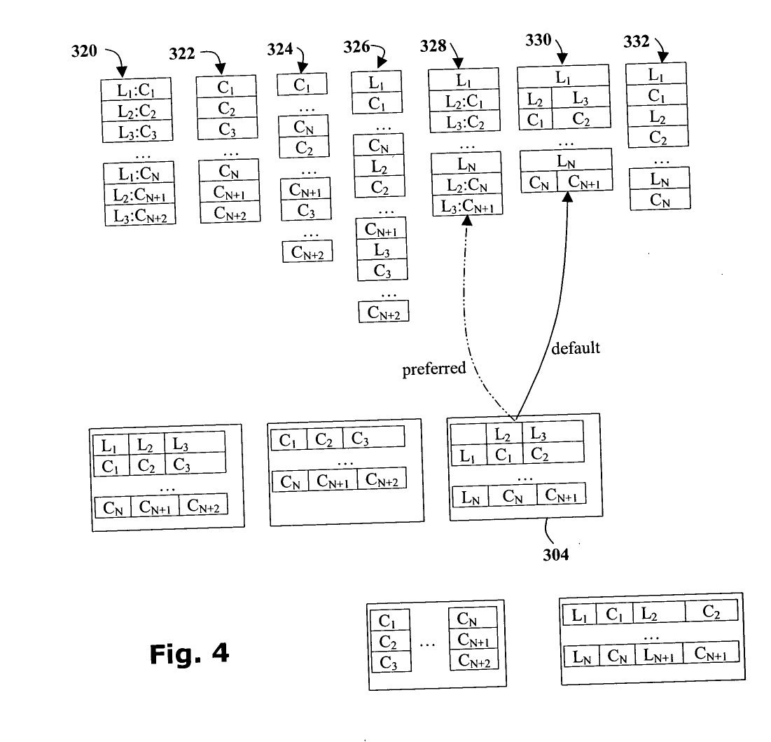

FIG. 4 provides an alternative embodiment in which a portion of the web site data has been stored according to the third predetermined template 304 (top side header). In this embodiment the author has specified two possible mappings to alternative templates (the row entry head row list 328 (the preferred mapping) and the row entry sub table 330 (the default mapping) alternative templates).

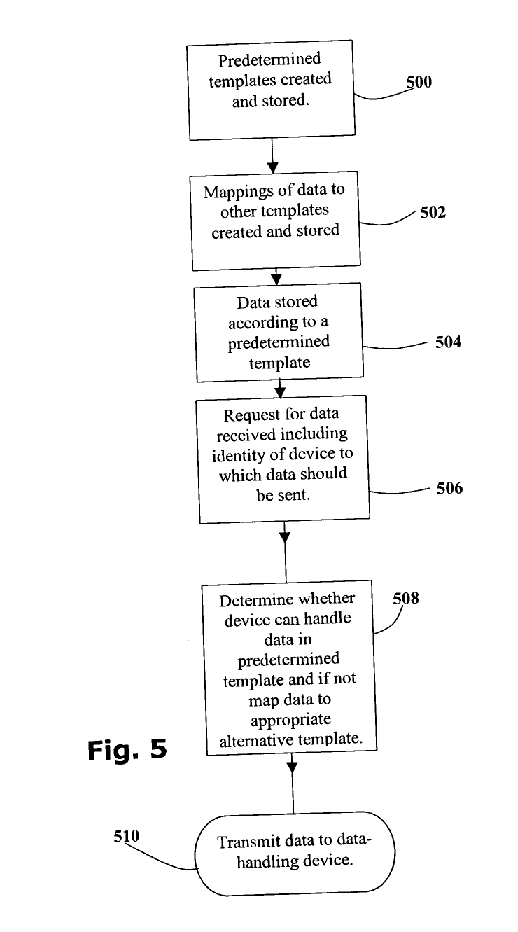

The processes that provide an embodiment of the invention are explained with reference to FIG. 5. As has been explained hereinbefore, at least a portion of the data for the web site is held according to a predetermined template 500 and thus the predetermined templates must be defined and stored on the server 100 (or elsewhere on the network). The alternative templates together with the mappings that map the cells of the predetermined template to the alternative templates are also created and stored 502. At least a portion of the data providing, in this example, the web site is then stored according to one of the predetermined templates 504, such that label data and content data are provided in appropriate fields of the selected predetermined template.

When a request for data 506 is made the identity of the data-handling device to which the data will be sent is passed to the server 100. The request may of course be made from the data-handling device to which the data will be sent, or from a different device which is requesting data on behalf of another device. Once the request for data has been received it is determined whether or not that device can handle data held according to the predetermined template. If the device cannot handle the data, the data is mapped to the appropriate alternative template (the preferred alternative template if possible, or one of the other alternative templates if the preferred template will still not work).

The appropriate template may be determined in a plurality of different manners, but in one embodiment data is maintained about the data-handling capabilities (generally display capabilities) for each data-handling device to which data may be sent. From this data and also an analysis of the data that is held in the predetermined template it will be possible to determine which alternative template will be appropriate to map the data to in order to allow it to be handled by the data-handling device.

In this embodiment the mapping will only be performed if it is deemed that the data-handling device cannot handle, generally display, the data as it is stored according to the predetermined template. For example, it will be appreciated that the PC 200 of FIG. 2 will have a higher display capability compared to the other devices and may generally be able to display data as it is stored in the predetermined template. Other devices such as the telephone 204 are likely to have a much lower display capability and as such it is more likely that the data will need to be mapped to an alternative template.

If a mapping is required, once the data has been mapped 506 to an alternative template it is transmitted to the data-handling device.

It will be appreciated that in the embodiment of FIG. 3 two possible mappings have been defined in addition to the default and predetermined alternative templates: to the row list 322 and the cell list 324 alternative templates. If it is possible to map the data from the predetermined template 300 to the either one of these templates then this mapping is performed. In general, the default mapping for a particular embodiment may be the least preferred but may have been checked to ensure that it allows data to handled (generally to be displayed) on all devices which may receive data. Therefore, if mappings other than the default mappings are available then these may be preferred for use instead of a default mapping.

The above describes one particular embodiment of how the mapping from the predetermined template 300-308 to one of the alternative templates 320-332 is selected. Generally, such methods require that the information is known about the data-handling device (its identity, its model, the class of device to which it belongs, or the like) and this information may be sent to the server 100 as a parameter by the data-handling device or the device requesting that data be sent to the data-handling device.

It will of course be appreciated that other methods of selecting a mapping are also possible. For example, it may be possible to send the data to a data-handling device by mapping the data to the preferred alternative template. Alternative mappings may then only be considered if an error message is received from the data-handling device from which the data was sent.

Although it will be appreciated that the mappings between the predetermined templates 300-308 and the alternative templates 320-332 could be held in any number of ways (for example, a database, a list or any other suitable form), in perhaps the preferred embodiment the mappings are contained in XML (extensible Mark-up Language) code, but could be equally stored using other mark-up languages or as a database. In one embodiment the data is held in a Device Independent Markup Language (DiML) based upon XML technology.

XML requires pairs of tags, or identifiers, to be placed within a document. Theses tags do not specify how the information should be presented, but specify the content of the information between the pairs of tags. The skilled person will fully understand XML, but a full description can be found at http://www.w3.org, and the brief description below will aid his/her understanding. An archive of this site may be found at http://web.archive.org/web/*/http://www.w3.org which also contains information about XML.

The skilled person will appreciate how data written as an XML document is structured: written in words, or data sub-items, which are collected into data sub-item groups. The data sub-item groups can comprise sentences, paragraphs, or simply collections of words. The data sub-item groups, or even just data sub-items, are placed between pairs of tags.

The tags appear as follows: <variable>, and </variable>, with variable being any word, or character string acceptable according to the XML recommendation. Further, each data sub item group can be itself broken down into a number of sub-items. This structure is convenient and allows for easy manipulation and searching of the complete data item. Each data sub-item group may of course be considered as a portion of the data.

A series of XML examples now follows:

| | |
|---|---|
| 1 | <adaptationRules name=“Handheld”> |
| 2 | |

| | |
|---|---|
| 3 | <group name=“layout-adaptation”> |

| | |
|---|---|
| 4 | <set name=“default”> |

| | |
|---|---|
| 5 | <preferred type=“string”value=“orderedFlow”/> |

| | |
|---|---|
| 6 | </set> |
| 7 | <set name=“standardHeader”> |

| | |
|---|---|
| 8 | <preferred type=“string”value=“headRowList”/> |

| | |
|---|---|
| 9 | </set> |
| 10 | <set name=“rowOrdCnt”> |

| | |
|---|---|
| 11 | <preferred type=“string”value=“rowList”/> |

| | |
|---|---|
| 12 | </set> |
| 13 | <set name=“colOrdCnt”> |

| | |
|---|---|
| 14 | <preferred type=“string”value=“cellList”/> |

| | |
|---|---|
| 15 | </set> |
| 16 | <set name=“topSideHeader”> |

| | |
|---|---|
| 17 | <preferred type=“string”value=“rowEntrySubTable“/> |

| | |
|---|---|
| 18 | </set> |
| 19 | <set name=“sideBySide”> |

| | |
|---|---|
| 20 | <preferred type=“string”value=“headRowList”/> |

| | |
|---|---|
| 21 | </set> |

| | |
|---|---|
| 22 | </group> |

| | |
|---|---|
| 23 | </adaptationRules> |
| 24 | |
| 25 | |

The XML file outlined above contains an example mapping for a class of device entitled handheld. Such a class of device may include devices such as PDA's 202, telephones 204, notebook computers, headsets 206. It can be seen that the above file defines a series of tags “set” which then specifies a name for that set and each of these corresponds to a predetermined template. For example line 4 defines the “default” set, line 7 defines the “standard header set”, line 10 defines the rowordcont set (row ordered content), line 13 defines the colordcnt set (column ordered content), line 16 defines the topsideheader set, line 19 defines the sidebyside set.

As can be seen from the beginning of the tag (e.g. line 20) this defines the alternative template that the author sees as being the preferred alternative template for the associated predetermined templates. In this embodiment, the default template is defined within the overall code running on the server 100 and therefore, does not need to be specified within the XML examples given. However, it will be appreciated that in other examples it would be possible provide this information within the XML itself.

It should be noted that for the example given in FIG. 3 the XML code should give the identity of the alternative templates to which the 1st and 2nd mappings should be directed, although this has not been shown in the example XML.

| | |
|---|---|
| 1 | <adaptationRules name=“PDA” extends=“HandheldRules”> |

| | |
|---|---|
| 2 | <group name=“layout-adaptation”> |

| | |
|---|---|
| 3 | <set name=“standardHeader”> |

| | |
|---|---|
| 4 | <preferred type=“string” value=“headCellList”/> |

| | |
|---|---|
| 5 | </set> |
| 6 | <set name=“topSideHeader”> |

| | |
|---|---|
| 7 | <preferred type=“string” value=“rowEntryHeadList”/> |

| | |
|---|---|
| 8 | </set> |
| 9 | <set name=“sideBySide”> |

| | |
|---|---|
| 10 | <preferred type=“string” value=“alternateList”/> |

| | |
|---|---|
| 11 | </set> |

| | |
|---|---|
| 12 | </group> |

| | |
|---|---|
| 13 | </adaptationRules> |
| 14 | |
| 15 | |

The above XML file extends the XML file described above the class of device “handheld” by providing specific instructions for a device within that class: the PDA. It would of course be possible to provide files for other devices within a class. It would also be possible to provide sub classes within the PDA class for example to specific models of PDA. It may also be possible to provide further levels of nesting.

1

| | |
|---|---|
| 2 | <adaptationRules name=“PC”> |
| 3 | |

| | |
|---|---|
| 4 | <group name=“layout-adaptation”> |

| | |
|---|---|
| 5 | <set name=“standardHeader”> |

| | |
|---|---|
| 6 | <preferred type=“string” value=“headRowList”/> |

| | |
|---|---|
| 7 | </set> |
| 8 | <set name=“rowOrdCnt”> |

| | |
|---|---|
| 9 | <preferred type=“string” value=“rowList”/> |

| | |
|---|---|
| 10 | </set> |
| 11 | <set name=“colOrdCnt”> |

| | |
|---|---|
| 12 | <preferred type=“string” value=“cellList”/> |

| | |
|---|---|
| 13 | </set> |
| 14 | <set name=“topSideHeader”> |

| | |
|---|---|
| 15 | <preferred type=“string” value=“rowEntrySubTable”/> |

| | |
|---|---|
| 16 | </set> |
| 17 | <set name=“sideBySide”> |

| | |
|---|---|
| 18 | <preferred type=“string” value=“headRowList”/> |

| | |
|---|---|
| 19 | </set> |
| 20 | <set name=“default”> |

| | |
|---|---|
| 21 | <preferred type=“string” value=“orderedFlow”/> |

| | |
|---|---|
| 22 | </set> |

| | |
|---|---|
| 23 | </group> |

| | |
|---|---|
| 24 | </adaptationRules> |
| 25 | |
| 26 | |
| 27 | |

The above XML file provides a set of definitions for the class of device PC.

In some embodiments it may be possible to add dynamic data to the data being sent to the data-handling device. Either or both of the label/content data may comprise dynamic data. Dynamic data is data that may only be determinable at roughly the time that the data is to be sent to the data-handling device. Therefore, the dynamic data may not be known with certainty until the web-site is accessed and viewed by a user which may be due to a number of different reasons. For example, the dynamic data may be time dependent in some manner, it may be specific to the location of the user (for example weather information), it may be dependent upon the identity of the user (for example bank account details), or other similar situations.

The embodiments described herein may allow an adaptation system in a more intelligent manner than serialising each area as has previously been performed by the prior art. In particular, embodiments of the invention may allow grid layouts to be converted to “flow” layouts that generally fit better onto small displays (for example of mobile telephones). It will be appreciated that if for example content data from models such as the top side header model 304 is divorced from the labels and simply listed one cell after the other that the meaning of the table may well be lost. Therefore, using techniques as described herein may allow the intent of the author to be preserved.

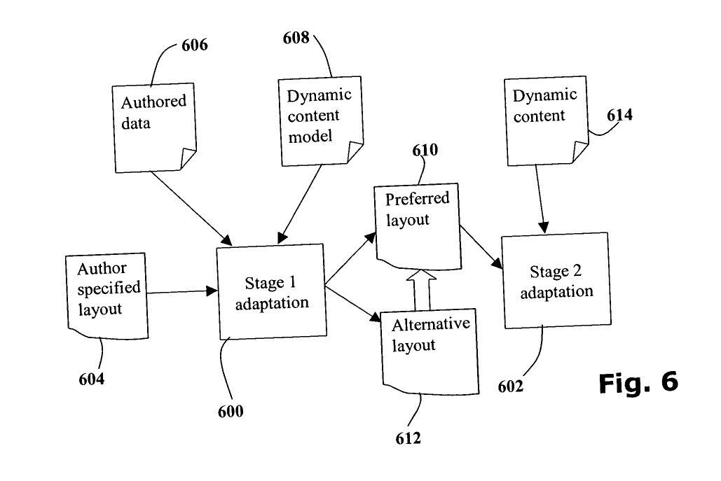

The embodiments described herein may be applicable to two stage adaptation processes in which an initial set of data is prepared in a first stage to generate device specific, or device class specific, data which is stored for later use and augmented with other data at roughly the time data is transmitted. An example of such a process is shown in FIG. 6 provides an overview of the processes of one embodiment of the present invention and comprises two stages: stage one 600 and stage two 602. The stage one 600 process takes as its inputs an author specified layout 604, authored (static) data 606 and a model 608 of dynamic data which may be expected. The first stage process takes these inputs and generates at least one version of data suitable for sending to a class of data-handling device. In this embodiment a preferred 610 and an alternative 612 are generated. Turning to FIG. 5 the stage one process may perform the first three steps, 500, 502 and 504.

In the second stage process 302 dynamic data is added to the data that has been created in the first stage. In the embodiment of FIG. 6 the author of the data may create the authored (static) data 606 such at least a portion of that data is written according to the predetermined template. The first stage adaptation process 600 may then map the data to alternative templates as described herein. Again, turning to FIG. 5, the last three steps may be performed by the stage two process once the request for data has been received.

A template may be thought of as a model for the data layout. The mapping may be thought of as a transformation. Thus a mapping or a transformation may be thought of as transforming one model of data layout into a second different model of data layout. Thus, data may be stored according to a non-unique model which a user selects. Mappings may be provided that map the data to an alternative model should it be decided that the original model is not suitable for sending to a data-handling device. In some embodiments it is possible to prioritise which mappings are performed in preference to other mappings.

What we claim is:

1. A method of delivering data to at least one data-handling device, the method comprising the steps of:
i. storing data that is intended for transmission to the data-handling device according to a predetermined template which provides a plurality of fields, each of the fields being capable of containing a portion of the data;
ii. providing mappings that map the data within the fields of the predetermined template to fields within alternative templates should it be determined that the data-handling device is not capable of handling data held in the predetermined template; and
iii. transmitting the data to the data-handling device.

2. A method according to claim 1 in which the method provides a plurality of predetermined templates in any one of which data may be stored.

3. A method according to claim 2 in which the method provides a plurality of alternative templates such that data provided in any of the predetermined templates can be mapped to at least one of the alternative templates.

4. A method according to claim 3 which comprises specifying a plurality of mappings from the predetermined to the alternative templates.

5. A method according to claim 4 which ensures that at least one mapping allows data to be mapped to an alternative template such that the data can be handled by substantially all data-handling devices that may be sent data.

6. A method according to claim 4 in which at least a preferred and an alternative mapping are defined.

7. A method according to claim 1 which comprises determining whether the data-handling device is capable of handling data before transmission to the data-handling device and mapping the data using the mappings should it be determined that the data-handling device cannot handle the predetermined template.

8. A method according to claim 1 in which the method is arranged to determine whether the data-handing device is capable of handling the data after it has been transmitted to the data-handling device.

9. A computing device capable of delivering data to at least one data-handling device, the computing device comprising a receiving means for receiving a request for data, a transmitting means arranged to transmit data, a processing means arranged to process data and a storage means for storing data, the receiving means is arranged to communicate the receipt of a request for data to the processing means which is arranged, upon the receipt of such a communication, to retrieve data from the storage means which has been stored according to a predetermined template which provides a plurality of fields such that each of the fields is capable of containing a portion of the data, the storage means also being arranged to store mappings which are arranged to map data held in fields of the predetermined template to fields within alternative templates, the processing means being capable of mapping data stored in the predetermined template to alternative templates according to the mappings and sending the mapped data to the transmitting means for transmission.

10. A network capable of delivering data to at least one data-handling device, the network comprising a receiving means for receiving a request for data, a transmitting means arranged to transmit data, a processing means arranged to process data and a storage means for storing data, the receiving means is arranged to communicate the receipt of a request for data to the processing means which is arranged, upon the receipt of such a communication, to retrieve data from the storage means which has been stored according to a predetermined template which provides a plurality of fields such that each of the fields is capable of containing a portion of the data, the storage means also being arranged to store mappings which are arranged to map data held in fields of the predetermined template to fields within alternative templates, the processing means being capable of mapping data stored in the predetermined template to alternative templates according to the mappings and sending the mapped data to the transmitting means for transmission.

11. A data-handling device capable of communicating with a computing device and/or network and receiving data therefrom, the data-handling device being arranged to communicate a parameter such that the method of claim 1 can be applied to the data that is sent to the data-handling device.

12. A machine-readable medium containing instructions which when read by a computing device cause that computing device substantially to perform the method of claims 1.

13. A machine-readable medium containing instructions which when read by a computing device cause that computing device to function substantially as the computing device of claim 9.

14. A machine-readable medium containing instructions which when read by a computing device of a network cause that network to function substantially as the network of claim 10.

15. A machine-readable medium containing instruction which when read by a data-handling device cause that data-handling device to function substantially as the data-handling device as the data handling device of claim 11.

16. A method of delivering data to at least one data-handling device, the method comprising the steps of:
i. storing data that is intended for transmission to the data-handling device in one of a plurality of predetermined templates each of which provides a plurality of fields and each of the fields being capable of containing a portion of the data;
ii. providing a plurality of mappings that map data held within a field of one of the predetermined templates to fields within an alternative template should it be determined that the data-handling device to which the data is to be sent is not capable of handling data held in the predetermined template;
iii. altering the data according to one of the mappings should it be determined that the data-handling device cannot handle the data; and
iv. transmitting the data to the data-handling device.

17. A method according to claim 16 which allows the mappings to be ranked such that at least one of the mappings is performed in preference to at least one of the other mappings.

18. A method of delivering data to at least one data-handling device, the method comprising the steps of:
i. storing data that is intended for transmission to the data-handling device in one of a plurality of predetermined templates each of which provides a plurality of fields and each of the fields being capable of containing a portion of the data;
ii. providing a plurality of mappings that map data held within a field of one of the predetermined templates to fields within an alternative template should it be determined that the data-handling device to which the data is to be sent is not capable of handling data held in the predetermined template, the predetermined mappings including at least a preferred mapping which is performed in preference to other mappings should it be determined that a mapping is required and a default mapping that is performed if other mappings do not map the data such that it can be handled by the data-handling device;
iii. altering the data according to one of the mappings should it be determined that the data-handling device cannot handle the data; and
iv. transmitting the data to the data-handling device.

19. A computing device capable of delivering data to at least one data-handling device, the computing device comprising a receiver, a transmitter, a processor and a memory, the receiver is arranged to communicate the receipt of a request for data to the processor which is arranged, upon the receipt of such a request, to retrieve data from the memory which has been stored in the memory in one of a plurality of predetermined templates each of which provides a plurality of fields such that each of the fields is capable of containing a portion of the data, the memory also being arranged to store mappings which are arranged to map data held in fields of the predetermined template to fields within alternative templates, the processor being capable of mapping data stored in the predetermined template to alternative templates according to the mappings and sending the mapped data to the transmitter for transmission.

20. A network capable of delivering data to at least one data-handling device, the network comprising a receiver, a transmitter, a processor and a memory, the receiver is arranged to communicate the receipt of a request for data to the processor which is arranged, upon the receipt of such a request, to retrieve data from the memory which has been stored according to one of a plurality of predetermined templates each of which provides a plurality of fields such that each of the fields is capable of containing a portion of the data, the memory also being arranged to store mappings which are arranged to map data held in fields of the predetermined template to fields within alternative templates, the processor being capable of mapping data stored in the predetermined template to alternative templates according to the mappings and sending the mapped data to the transmitter for transmission.

21. A method of sending data to at least one remote device, the method comprising the steps of:
i. storing data that it is intended to send to the remote device in one of a plurality of predetermined templates each of which provides a plurality of fields and each of the fields allowing a portion of the data to be stored therein;
ii. providing a plurality of transformations that transform data held within one of the plurality of templates such that the data then corresponds to an alternative template such that data held in a field of one of the predetermined templates is moved to a field within the alternative template;
iii. transforming the data according to one of the transformations should it be determined that the remote device cannot handle the data as it is stored in the predetermined template;
iv. and sending the data to the remote device.
